(19) United States
(12) Patent Application Publication
(10) Pub. No.: US 2019/0146067 A1
(43) Pub. Date: May 16, 2019

(54) FLASH LIDAR SENSOR ASSEMBLY

(71) Applicant: Continental Automotive Systems, Inc., Auburn Hills, MI (US)

(72) Inventors: Heiko Leppin, Santa Barbara, CA (US); Jürgen Brugger, Neukirch (DE)

(73) Assignee: Continental Automotive Systems, Inc., Auburn Hills, MI (US)

(21) Appl. No.: 16/190,583

(22) Filed: Nov. 14, 2018

Related U.S. Application Data
(60) Provisional application No. 62/585,866, filed on Nov. 14, 2017.

(51) Int. Cl. G01S 7/481

(52) U.S. Cl. CPC G01S 7/4813; G01S 7/4863; G01S 7/4818; G01S 7/4817

(57) ABSTRACT

A flash lidar sensor assembly includes a first housing and at least one laser light source disposed in the first housing. The at least one laser light source is configured to generate a first field of illumination of light and a second field of illumination of light. The assembly also includes a second housing separate from the first housing. A first light receiver unit and a second light receiver unit are disposed in the second housing. The first light receiver unit is configured to receive light of the first field of illumination reflected off at least one object. The second light receiver unit is configured to receive light of the second field of illumination reflected off at least one object.

### CROSS REFERENCE TO RELATED APPLICATION

This application claims the benefit of provisional patent application No. 62/585,866, filed Nov. 14, 2017, which is hereby incorporated by reference.

### TECHNICAL FIELD

The technical field relates generally to lidar sensors and more particularly to flash lidar sensors.

### BACKGROUND

Flash lidar sensors typically provide either a long range or a wide field of view. If both are required, a combination of multiple lidar sensors are often utilized, which may be very costly.

As such, it is desirable to present a single flash lidar sensor which provides both a long range and a wide field of view. In addition, other desirable features and characteristics will become apparent from the subsequent summary and detailed description, and the appended claims, taken in conjunction with the accompanying drawings and this background.

### BRIEF SUMMARY

In one exemplary embodiment, a flash lidar sensor assembly includes a first housing. At least one laser light source is disposed in the first housing and is configured to generate a first field of illumination of light and a second field of illumination of light. The assembly also includes a second housing separate from the first housing. A first light receiver unit and a second light receiver unit are disposed in the second housing. The first light receiver unit is configured to receive light of the first field of illumination reflected off at least one object. The second light receiver unit is configured to receive light of the second field of illumination reflected off at least one object.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a schematic representation of a flash lidar sensor assembly with a pair of transmitting units in a first housing and a pair of receiving units in a second housing, according to an exemplary embodiment;

FIG. 2 is a schematic representation of one of the transmitting units of the exemplary embodiment of FIG. 1;

FIG. 3 is a schematic representation of the flash lidar sensor assembly with a single transmitting unit in the first housing and the pair of receiving units in the second housing, according to an exemplary embodiment;

FIG. 4 is a schematic representation of the transmitting unit of the exemplary embodiment of FIG. 3;

FIG. 5 is a schematic representation of the flash lidar sensor assembly according to another exemplary embodiment;

FIG. 6 is a diagram showing a minimum sensing distance utilizing a single field of illumination and a single field of view according to one exemplary embodiment; and

FIG. 7 is a diagram showing a minimum sensing distance utilizing multiple fields of illumination and a single field of view according to one exemplary embodiment.

### DETAILED DESCRIPTION

Referring to the Figures, wherein like numerals indicate like parts throughout the several views, a flash lidar sensor assembly 100 is shown and described herein.

In the exemplary embodiments, the flash lidar sensor assembly 100 includes a first housing 102 and a second housing 104. In one exemplary embodiment, the housings 102, 104 are physically separate and isolated from one another. However, in some embodiments, the housings 102, 104 may share structural elements (not shown).

The flash lidar sensor assembly 100 also includes at least one light transmitter unit 106. The at least one light transmitter unit 106 is disposed in the first housing 102. The at least one light transmitter unit 106 is configured to generate a first field of illumination 110 of light and a second field of illumination 112 of light. The fields of illumination 110, 112 are each three-dimensional spaces generated by a pulse of laser light that is scattered through a diffusion process, as described further below.

In the exemplary embodiments, the first field of illumination 110 is more particularly configured to illuminate objects (not shown) near the sensor assembly 100. As such, the first field of illumination 110 may be referred to as a wide-angle illumination or close-range illumination. The second field of illumination 112 is more particularly configured to illuminate objects (not shown) farther from the sensor assembly 100. As such, the second field of illumination 112 may be referred to as a narrow-angle illumination or long-range illumination.

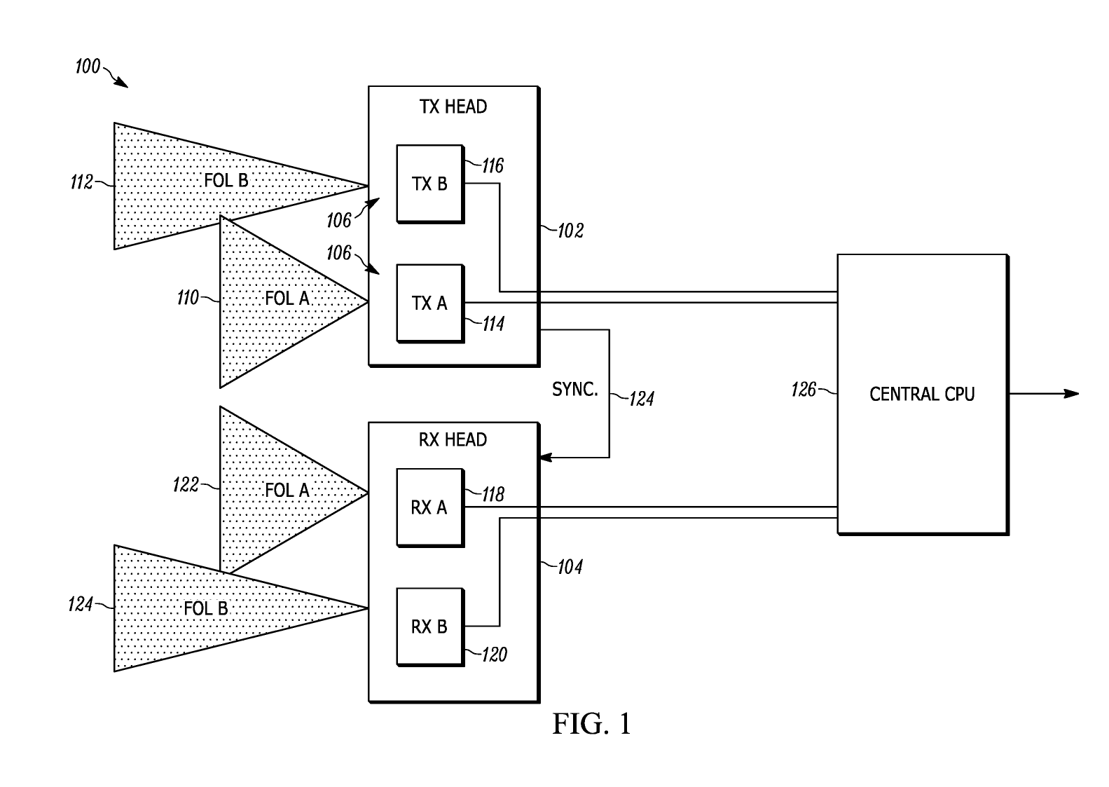

In the exemplary embodiment shown in FIG. 1, the at least one light transmitter unit 106 is implemented as a first light transmitter unit 114 and a second light transmitter unit 116. The first light transmitter unit 114 is configured to generate the first field of illumination 110 while the second light transmitter unit 116 is configured to generate the second field of illumination 112.

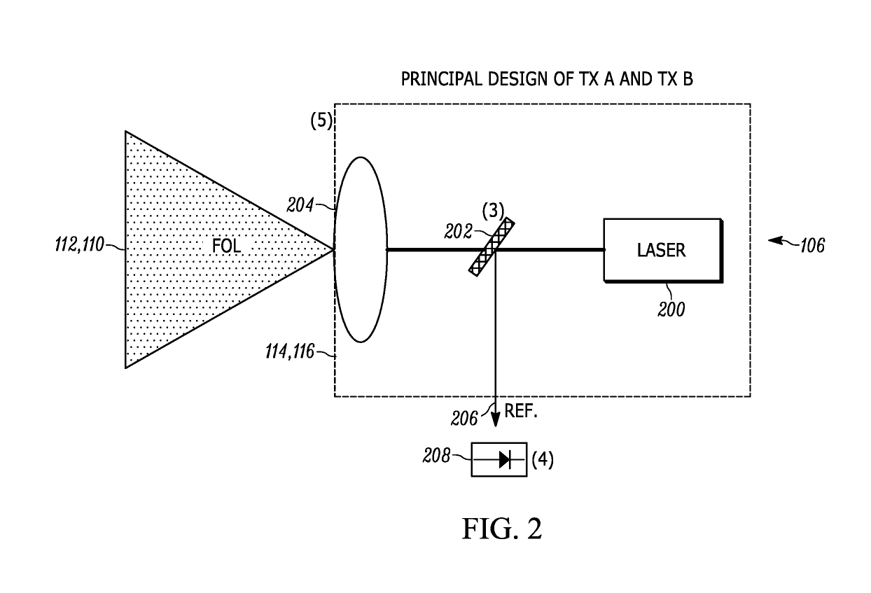

Each light transmitter unit 114, 116 includes at least one laser light source 200, as shown in FIG. 2. Each light transmitter unit 114, 116 also includes a beam splitter 202 and an optical element 204. The beam splitter 202 receives a beam of light from the at least one laser light source 200, directs most of the light to the optical element 204, and directs a portion of the light away from the optical element as a reference beam 206. In the embodiment shown in FIG. 2, a photodiode 208 receives the reference beam 206 to generate a synchronization signal 124 as described in greater detail below. The fields of illumination 110, 112 may be generated by momentary actuation (i.e., pulses) of each laser light source 200. The optical elements 204 then diffuse the pulse of light to generate the fields of illumination 110, 112.

Referring again to FIG. 1, the flash lidar sensor assembly 100 includes a first light receiver unit 118 and a second light receiver unit 120. The light receiver units 118, 120 are disposed in the second housing 104.

The first light receiver unit 118 is configured to receive light in a first field of view 122. The first field of view 122 corresponds to the light of the first field of illumination 110 that is reflected off at least one object (not shown). The second light receiver unit 120 is configured to receive light in a second field of view 124. The second field of view 124 corresponds to the light of the second field of illumination 112 that is reflected off at least one object (not shown).

In the exemplary embodiments, each light receiver unit 118, 120 includes an array of photodetectors (not shown).

The light receiver units 118, 120 are in communication with the at least one transmitter unit 106 via the synchronization signal 124. The synchronization signal 124 may be utilized to determine the time that a light pulse of the at least one laser light source 200 is generated. The light receiver units 118, 120 may utilize this signal 124 to determine the distance that the light traveled to and from the object, thus enabling calculation of the distance to the object.

By separating the light receiver units 118, 120 from the light transmitter units 114, 116, the need for aggressive heat dissipation is reduced, as compared to when the receiver units 118, 120 and transmitter units 114, 116 are packaged together. Furthermore, electromagnetic interference is also reduced between the receiver units 118, 120 and transmitter units 114, 116.

The flash lidar sensor assembly 100 also includes a controller 126. The controller 126 includes processing unit (not shown), e.g., a microprocessor, which is configurable to perform mathematical calculations and/or execute instructions (i.e., run a program). In the exemplary embodiment of FIG. 1, the controller 126 is in communication with the light transmitter units 114, 116 and the light receiver units 118, 120. As such, the controller 126 may control operation of these units 114, 116, 118, 120, including, but not limited to, the activation of the at least one laser light source 200.

In the exemplary embodiment of FIG. 1, the controller 126 is disposed remote from the first housing 102 and the second housing 104. However, it should be appreciated that the controller 126 may be disposed in one of the housings 102, 104. The controller 126 may be in communication with other systems, e.g., systems for control of a vehicle.

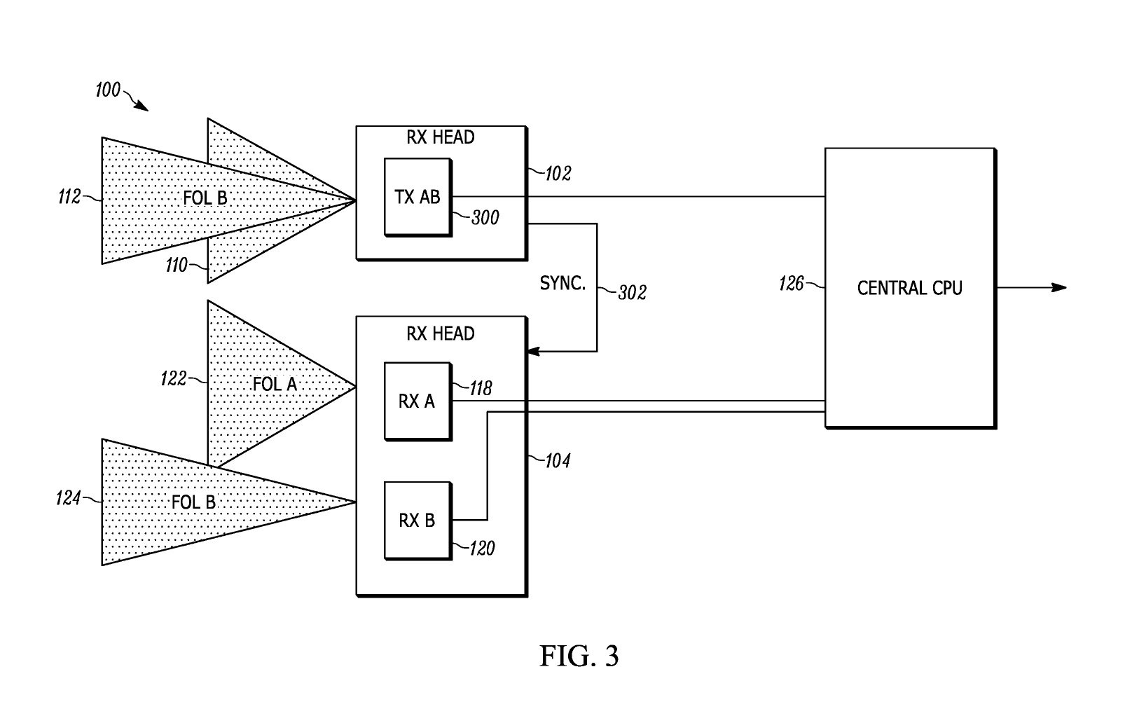

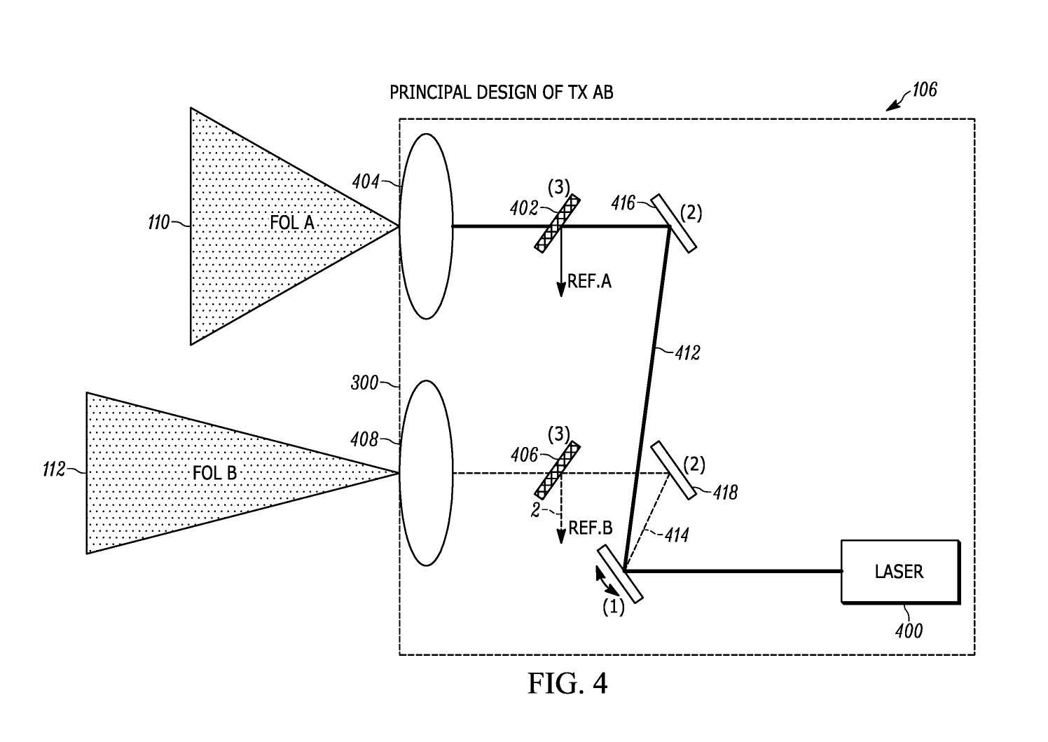

In the embodiment shown in FIGS. 3 and 4, the at least one light transmitter unit 106 is implemented with a single light transmitter unit 300. As such, the single light transmitter unit 300 is configured to produce both the first field of illumination 110 and the second field of illumination 112.

Referring to FIG. 4, the single light transmitter unit 300 includes a single laser light source 400. The single light transmitter unit 300 also includes a first beam splitter 402, a first optical element 404, a second beam splitter 406, and a second optical element 408. Each light transmitter unit 114, 116 also includes a beam splitter 202 and an optical element 204.

The unit 300 also includes a mirror 410 configured to varyingly direct light from the laser 400 to the first optical element 404 and the second optical element 408. The mirror 410 may be implemented as a microscanner, also commonly referred to as a micro-scanning mirror, a micro-opto-electromechanical system (“MOEMS”) mirror, or simply a MEMS mirror. However, it is to be appreciated that other devices and techniques may be utilized to implement the mirror 410. The controller 126 may be in communication with the mirror 410 to control operation of the mirror, e.g., in sync with alternating light pulses.

In the embodiment shown in FIG. 4, the mirror 410 varyingly directs light along a first path 412 or a second path 414. A first mirror 416, the first beam splitter 402, and the first optical element 404 are positioned along the first path 412, while a second mirror 418, the second beam splitter 406, and the second optical element 408 are positioned along the second path 414.

The first beam splitter 402 directs a portion of the first path 412 of light away as a first reference beam 420. The second beam splitter 406 directs a portion of the second path 414 of light away as a second reference beam 422. The first and second reference beams 420, 422 may be utilized to generate a synchronization signal 302 as shown in FIG. 3.

In the embodiment shown in FIGS. 3 and 4, one advantage is the use of the single laser light source 400 which may generate both the first and second field of illumination 110, 112. By utilizing just the single laser 400, not only is the cost of the assembly 100 drastically reduced, but heat management and interference issues are also reduced.

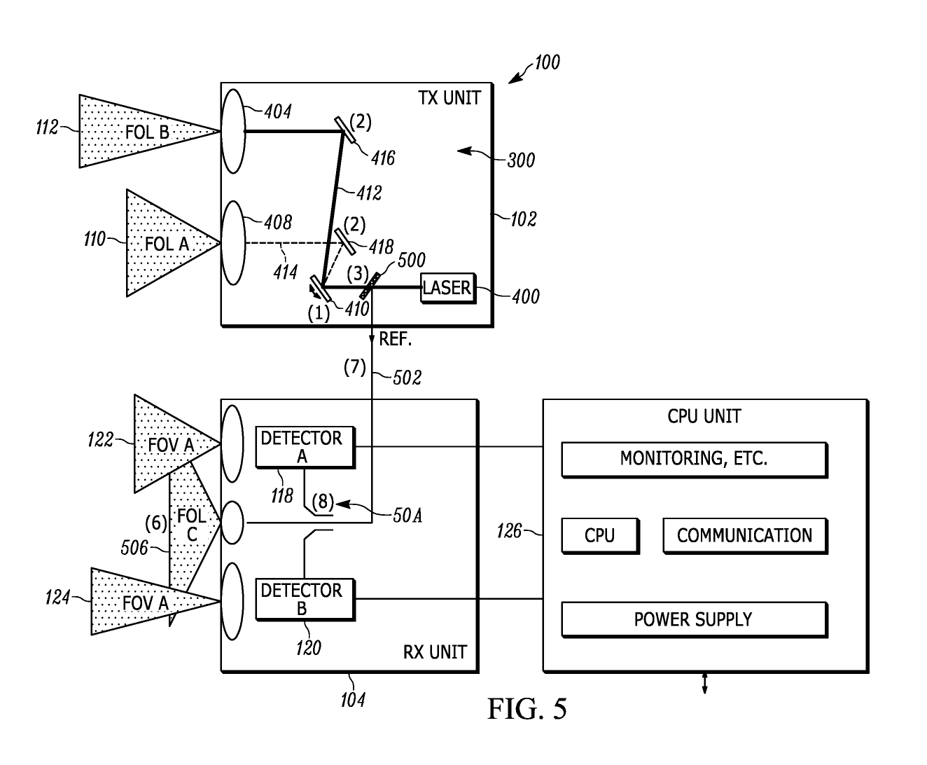

FIG. 5 illustrates a further embodiment of the flash lidar sensor assembly 100. This embodiment employs a single beam splitter 500 positioned between the single laser light source 400 and the mirror 410. This beam splitter 500 directs some of the light generated by the single laser light source 400 to the mirror 410 and directs some of the light generated by the single laser light source 400 to a fiber optic 502.

The fiber optic 502 routes the light from the first housing 102 to the second housing 104. An optical splitter 504 is disposed in the second housing 104 and in optical communication with the fiber optic 502. The optical splitter 504 is also in optical communication with the first light receiver unit 118 and the second light receiver unit 120. The optical splitter 504 is configured to guide light from the fiber optic 502 to each light receiver unit 118, 120. In particular, each light receiver unit 118, 120 includes a photo detector (e.g., one detector of the photo detector array) (not shown), to receive the light from the fiber optic 502. This light is utilized as a reference, as described above, to assist in calculating the distance of one or more objects.

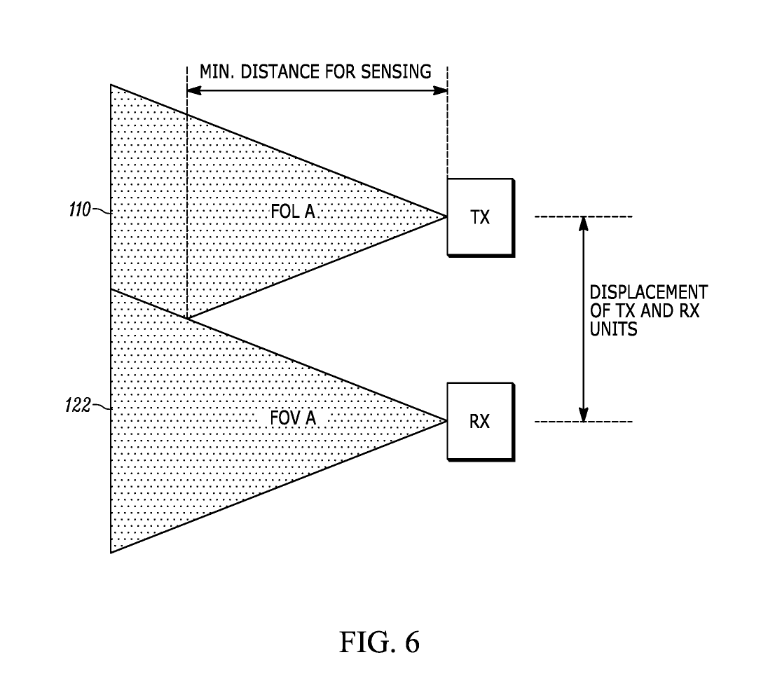

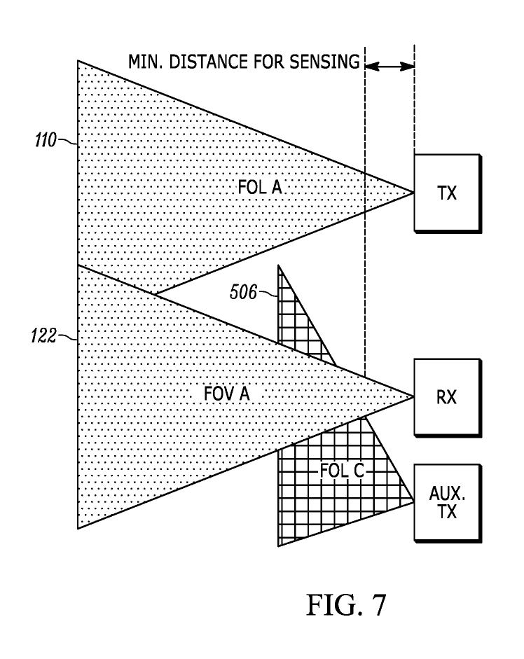

The light received at the second housing 104 from the fiber optic 502 may also be utilized to generate a third field of illumination 506. This third field of illumination 506 may be utilized to reduce the minimum distance required for sensing of objects. As shown in FIG. 6, the minimum distance for sensing an object is defined as the distance at which an overlap occurs between one of the fields of illumination 110 and one of the fields of view 122. By utilizing the third field of illumination 506, as shown in FIG. 7, the minimum distance can be reduced to the overlap that occurs between the first field of view 122 and the third field of illumination 506. Furthermore, the intensity of light produced in the third field of illumination 506 need not be as high as those in the first and second fields of illumination 110, 112.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A flash lidar sensor assembly comprising:
a first housing;
at least one laser light source disposed in said first housing for generating a first field of illumination of light and a second field of illumination of light;
a second housing separate from said first housing; and
a first light receiver unit and a second light receiver unit disposed in said second housing;
said first light receiver unit configured to receive light of the first field of illumination reflected off at least one object; and
said second light receiver unit configured to receive light of the second field of illumination reflected off at least one object.

2. The flash lidar sensor assembly as set forth in claim 1, further comprising:
a first optical element configured to receive light from said at least one laser light source and generate the first field of illumination; and
a second optical element configured to receive light from said at least one laser light source and generate the second field of illumination.

3. The flash lidar sensor assembly as set forth in claim 2, wherein said at least one laser light source is a single laser light source.

4. The flash lidar sensor assembly as set forth in claim 3, further comprising a mirror configured to varyingly direct light from said laser light source to said first optical element and said second optical element.

5. The flash lidar sensor assembly as set forth in claim 4, wherein each of said optical element includes a lens.

6. The flash lidar sensor assembly as set forth in claim 5, further comprising at least one beam splitter for directing some of the light generated by said single laser light source to said mirror and directing some of the light generated by said single laser to a fiber optic.

7. The flash lidar sensor assembly as set forth in claim 6, further comprising an optical splitter in optical communication with said fiber optic, said first light detector, and said second light detector, and configured to guide light from said fiber optic to said detectors.

8. The flash lidar sensor assembly as set forth in claim 6, wherein said second housing defines an exit aperture and said fiber optic is in optical communication with said exit aperture to define a third field of illumination.

9. The flash lidar sensor assembly as set forth in claim 6, further comprising a controller in communication with said single laser light source, said mirror, said first light detector, and said second light detector.

10. The flash lidar sensor assembly as set forth in claim 7, wherein said controller is disposed remote from said first housing.

11. The flash lidar sensor assembly as set forth in claim 10, wherein said controller is disposed separate from said second housing.
